(19) United States
(12) Patent Application Publication
(10) Pub. No.: US 2008/0061105 A1
(43) Pub. Date: Mar. 13, 2008

(54) Electrically Powered Tool

(76) Inventors: Jonas Zachrisson, Hjo (SE); Per Sundstrom, Jarfalla (SE)

Correspondence Address: SCHWEGMAN, LUNDBERG & WOESSNER, P.A., P.O. BOX 2938, MINNEAPOLIS, MN, 55402, US

(21) Appl. No.: 11/596,797

(22) PCT Filed: Jun. 17, 2005
(86) PCT No.: PCT/SE05/00931

§ 371 Date: Nov. 17, 2006

(51) Int. Cl. B25C 1/06; B27F 7/00; H02J 7/00

(52) U.S. Cl. 227/131; 227/120; 320/114; 320/132

(57) ABSTRACT

The invention relates to an electrically powered tool for fastening elements and comprising a moving shuttle (10) connected to a driver (13), and an actuator motor having at least two electromagnetic yoke assemblies (8, 9), cooperating with said shuttle (10) which is arranged to be displaced in relation to said yoke assemblies (8, 9), wherein each yoke assembly (8, 9) has electric coils (15) arranged for generating a magnetic field through the shuttle (10), and a control unit which controls the current in the coils (15) to generate a magnetic field so that a force is generated for displacing said shuttle (10). According to the invention, the yoke assemblies (8, 9) are arranged for generating a magnetic field which is directed generally perpendicular to the direction of movement of said shuttle (10).

### FIELD OF THE INVENTION

The present invention relates to an electrically powered tool for fastening elements and comprising a moving shuttle connected to a driver, and an actuator motor having at least two electromagnetic yoke assemblies, cooperating with said shuttle which is arranged to be displaced in relation to said yoke assemblies, wherein each yoke assembly has electric coils arranged for generating a magnetic field through the shuttle, and a control unit which controls the current in the coils to generate a magnetic field so that a force is generated for displacing said shuttle.

### BACKGROUND OF INVENTION

A nail, tack or staple is used to attach parts of different kinds of wood or other soft material where a nail, tack or staple is used as suitable fasteners. To drive down a nail, tack or staple into its foundation a hammer can be used. In industrial applications, a tacker or staple tool is used to drive down those fasteners.

Normally a tacker or staple tool uses compressed air as a driving media. Compressed air is normally only available within manufacturing facilities because it needs a compressor to compress the air and a distribution system for the compressed air. The distribution system normally consists of steel tubes and at ends of the tube the system has a pressure-reducing valve with an air cleaner and a fast connection adapter.

A tacker or staple tool is normally a hand held tool and therefore needs a rubber hose between the tool and the connecting point at the end of the distribution system.

The advantage with tools using compressed air is that they are small and light. The disadvantage is that they need compressed air and it is not occurring frequently. Mostly it only exists within manufacturing plants. If the tacker or stapler is a hand held tool it also needs a long and bulky hose between the tool and the connection point for the operator to move around freely.

Several different solutions have been patented to avoid the disadvantages discussed in the above text. Several patents exist on tools using electricity to drive an electric motor, which will tension a spring (U.S. Pat. No. 5,503,319), speed up a flywheel (U.S. Pat. No. 5,511,715) or energize one or two electric coils together with a spring (U.S. Pat. No. 4,618,087). These ideas will make use of electric power where the unit is connected through an electric cord to a wall outlet. Some other ideas are using cordless solutions by using some type of gas to drive a combustion unit (U.S. Pat. No. 5,720,423).

There is known a battery powered tool, having a battery powering an electric motor which will speed up a flywheel and at the moment the flywheel has sufficient energy it will be connected to a linear actuator over a clutch system (U.S. Pat. No. 6,607,111). The disadvantage with a flywheel is that it will take several seconds to speed up and it will limit the frequency of nail or staple impacting.

Furthermore, the new trend of hand held tools like screwdrivers, drilling machines and jigsaws are to use battery power. Therefore a recent development of batteries has taken place and batteries have became smaller, lighter, and more powerful.

The U.S. Pat. No. 4,618,087 describes one or two coils which will be energized from 110 or 220 50/60 Hz voltage. According to U.S. Pat. No. 4,618,087 a round bar or shuttle is used, and the coil is wound around the bar with an air gap between the inside of the coil and the bar. When the coil is energized a magnet field is generated in the same direction as the bar is moving, i.e. in the longitudinal direction of the bar, and the bar will be pulled in inside the coil to fill up the coil interior. When the bar is in the start position in front of the coil the magnetic field is directed from one end of the coil to the other end and this type of coils will therefore be named air coils. Air coils do normally have only 40% in efficiency, which is relatively low. For this reason, this type of solution is not suitable for battery operation.

The patent document US 2004/0084503 teaches a nail-hammering apparatus with a hammer, a first and a second solenoid and a control device. The apparatus is arranged so that the second solenoid can be turned on in order to drive the hammer after the first solenoid.

### SUMMARY OF THE INVENTION

The object of the present invention is to provide an improved tool for fastening elements which can be made portable and battery-operated and which overcomes the disadvantages associated with the prior art.

This object is accomplished by means of a tool of the kind mentioned initially, which is characterized in that the yoke assemblies are arranged for generating a magnetic field which is directed generally perpendicular to the direction of movement of said shuttle.

The present invention relates to a battery powered hand held tacker or staple tool. The tacker or staple tool consists of an electric powered linear actuator motor controlled by a microcomputer module, a battery as energy source and a conventional nail or staple feeding system.

The linear actuator motor is using a set of electromagnetic yokes and a shuttle moving between the magnetic poles in these yokes. The shuttle has an energy absorbing spring in one end, which will be compressed when the shuttle moves backwards, and a driver pin in the other end to drive down the nail, tack or staple into its foundation.

The present invention can be implemented in the form of a new type of hand held cordless tacker or staple tool is taking advantage of the new developed battery technique and of new types of microcomputer technologies to make an electric linear actuator motor to drive a nail, tack or staple into its foundation.

Compared to known arrangements, it can be noted that the invention uses a magnetic yoke made from laminated magnetic soft iron and the magnetic field extends perpendicularly to the bar or shuttle moving direction over a soft iron ring in the shuttle. In this way the magnetic field will move inside iron except for two very small air gaps between the yoke and the shuttle. This type of magnetic design can be named iron core coils and will have 80% efficiency or better depending on the size of the air gap.

Other advantages with this type of design are a high mechanical density in the shuttle moving direction and as the tacker tool needs several yokes to generate the necessary power to impact a bigger nail or staple, packing density is important. If several air coils have to be used the total tool will be long and as this is a hand held tool the total tool size is important as well. A motor with a yoke and a shuttle arrangement has also the advantage of being able to fire many nails or staples per second.

### BRIEF DESCRIPTION OF DRAWINGS

FIGS. 1A and B is a 3D and a side view of a battery powered tacker or staple tool according to the invention.

FIGS. 2A and B is a 3D and a side view of a linear actuator motor with a shuttle.

FIGS. 3A and B is an exploded 3D and a front view of the magnetic yoke with coils and a distance part made from non magnetic material to the next yoke.

FIGS. 4A, B and C are two 3D views and one side view of the shuttle with a shuttle iron core spaced with shuttle distance parts. The shuttle will have a driver in one end and the energy absorbing spring in the other end.

FIGS. 5A, B, C and D are views which show the relation between the shuttle iron core, the magnetic poles in the yoke and timing bar at the start and ending points for current to flow through the coils.

FIG. 6 is a timing diagram between the different yoke coils to go on and off.

FIG. 7 is a shuttle return force diagram showing the relation between the motor force and the return spring force.

FIG. 8 is a shuttle impact force diagram showing the relation between the motor and spring force and the force curve for a 65 mm long nail to penetrate into a normal wood foundation.

FIG. 9 shows the relation between shuttle speeds, return and impact movement.

FIG. 10 shows an electrical circuit being used in an alternative embodiment of the present invention.

FIG. 11 is a side view of an alternative embodiment.

FIG. 12 is a further side view of an alternative embodiment.

### DETAILED DESCRIPTION OF PREFERRED EMBODIMENTS:

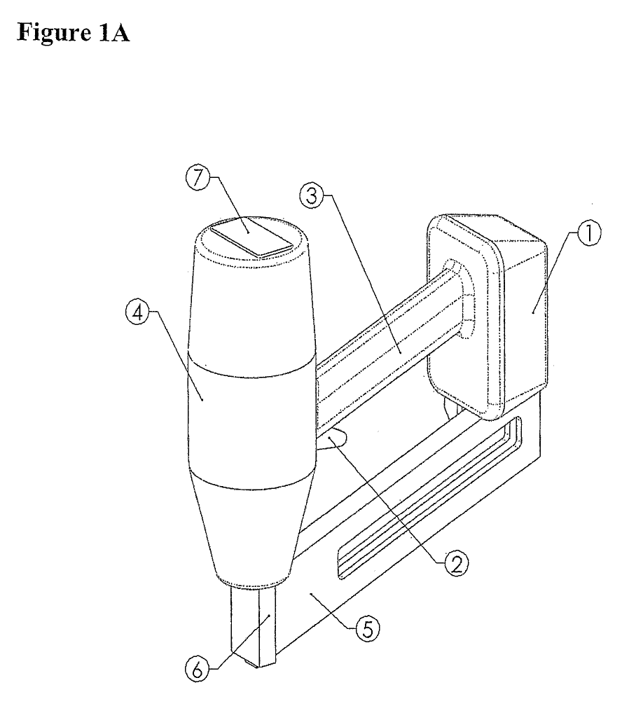

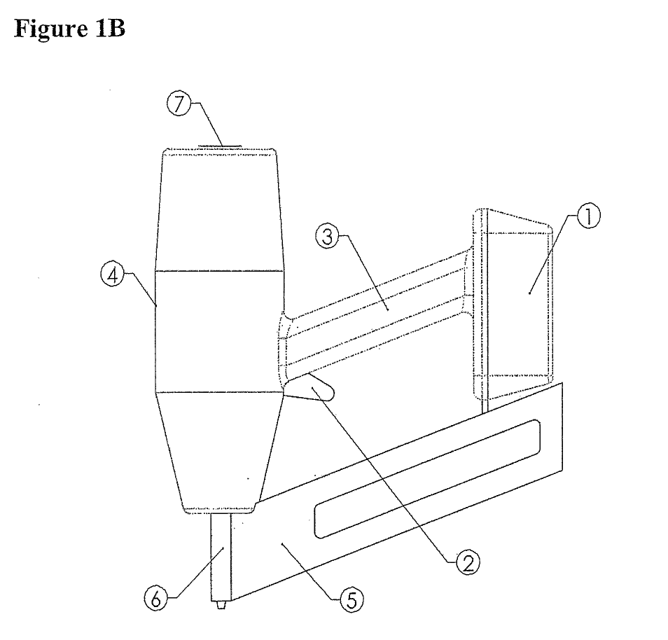

FIGS. 1A and B show a 3D and a side view of a battery powered tacker or staple tool according to an embodiment of the invention, comprising a rechargeable and replaceable battery 1. In one side of the handle 3 and on the other side a linear actuator motor is arranged, with a shuttle (not shown in FIGS. 1A and B) inside a housing 4. The shuttle movement starts with the actuation of a trigger 2 and as a result of this, the shuttle will move from its lowest position to the top position and back again. During this movement one nail, tack or staple in a feeder cassette 5 will move forward to a fire rail 6 and a driver arranged in front of the shuttle will be guided into the fire rail and drive down the nail, tack or staple into its foundation. On top of the housing 4 is a display 7 located and it will inform the operator of different tool status like time to chance battery or no nails, tacks or staples in the feeder cassette or other useful information.

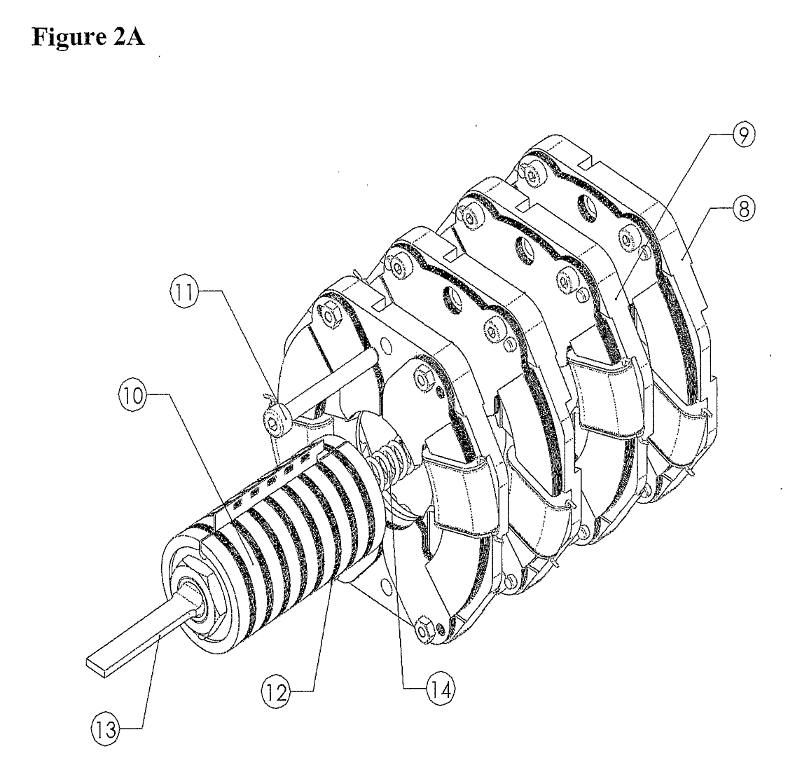

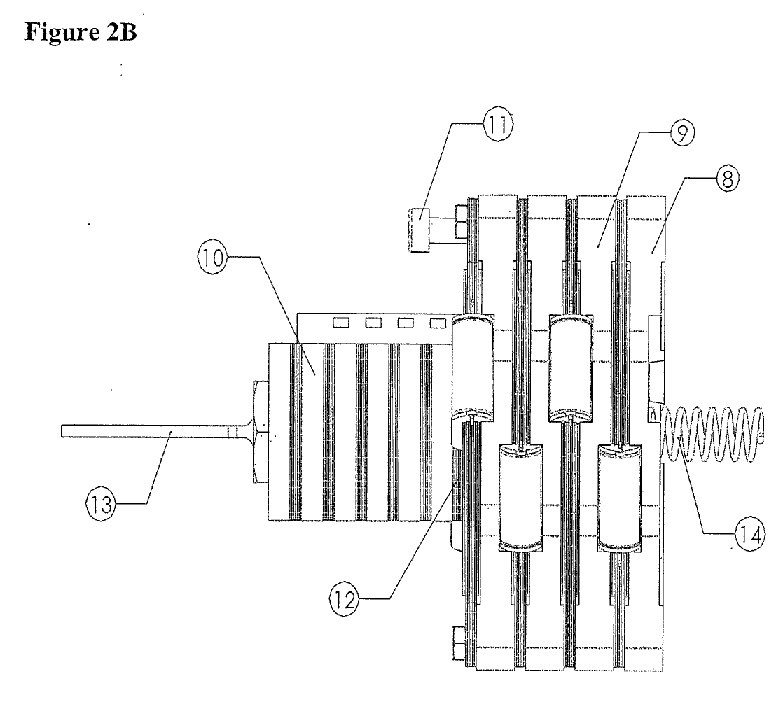

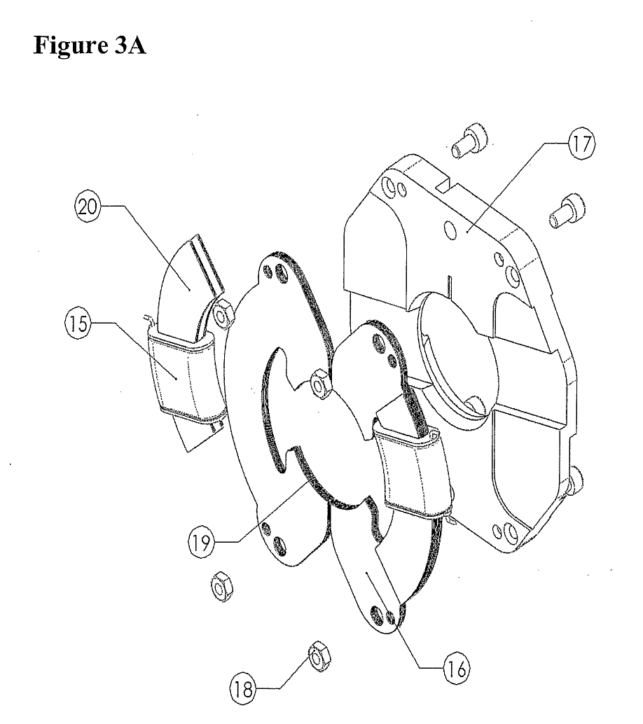

FIGS. 2A and B show a 3D and a side view of the linear actuator motor which is located in the staple tool housing 4 mentioned above. The motor is built together from two types of yoke assemblies, more precisely a first yoke assembly 8 and a second yoke assembly 9. As shown in detail in FIGS. 3A and 3B, the yoke assemblies 8, 9 are arranged with coils 15 at 10:00 and 16:00 a clock (i.e. the first yoke assembly 8) and with coils 15 at 8:00 and 14:00 a clock (i.e. the second yoke assembly 9). The two types of yoke assemblies are stacked after each other alternating between the first type 8 and the second type 9 of yoke assembly. FIG. 2A or B show four yoke assemblies but the motor can consist of a stack of a varying number of yoke assemblies depending on how much impact energy the motor has to deliver. In the center of the motor the shuttle 10 is located and the shuttle is guided by the center hole in the distance part 17 in the yoke assembly (se FIGS. 3A and B). Two screws 11 are holding the yoke assemblies together (only one screw is visible in the figure) and the yoke assemblies are lined up with each other to facilitate a perfect guiding of the shuttle 10. In the FIGS. 2A and B the front plate is removed by purpose to make the yokes 16 and coils 15 visible. In FIGS. 2A and B the driver 13 is assembled on the lower end of the shuttle and the shuttle is now in the start position with the driver 13 resting against the low end of the fire rail 6. In this position, some of the shuttle iron cores 12 are locate just in front of the yokes 16 in the yoke assembly to make it possible for the magnet field generated by the coils 15 to move through the yokes over an air gap of 0.05 to 0.1 mm between the yoke pole faces 19 and the shuttle iron core 12. When the magnet field is passing through the air gap a force is generated to move the shuttle forward into the motor to line up the shuttle iron core 12 inside the yoke 16. When the shuttle iron core 12 is lined up inside the yoke 16 the current over the coils 15 will shut down and the magnet field will end and no more force are generated by this yoke to move the shuttle.

The motor has several yokes and it will always have almost 50% of the yokes activated, and as soon as one yoke ends a new one will start. The shuttle will now move backwards into the motor and by doing this it will compress the energy absorbing spring 14 and the spring 14 will now transform the kinetic energy from the shuttle movement to static energy which can be used in the impact movement by the shuttle.

FIGS. 3A and B show a 3D and a front view of one yoke assembly. The yoke assembly consists of a distance 17 made from a non-magnetic material with good bearing properties for the bearing hole in the center. On top of the distance 17 two c-shaped yokes 16 are located facing each other. The yokes 16 are made from several magnetic sheet metal plates laminated together to form each yoke. On each yoke a coil 15 is assembled and between the coil and yoke one or two extra laminate plates 20 are located to make the area inside the coil equal to the area of the yoke pole face 19. The use of the extra magnetic plates 20 depends on the magnetic field inside the yoke if it will be saturated or not.

The two yokes 16 are located in a way so that the four pole faces 19 are forming a circle, which is concentric to the bearing hole in the center of the distance 17. After the four pole faces in the two yokes are positioned right in relation to the center hole in the distance 17 the two yokes are fastened with four fasteners 18. The diameter of the pole face circle is approximately 0.1 to 0.15 mm greater than the diameter of the bearing center hole in the distance 17. This difference will make up the air gap between the shuttle iron core 12 and the pole faces 19 as the shuttle 10 is guided by the bearing hole in the distance 17.

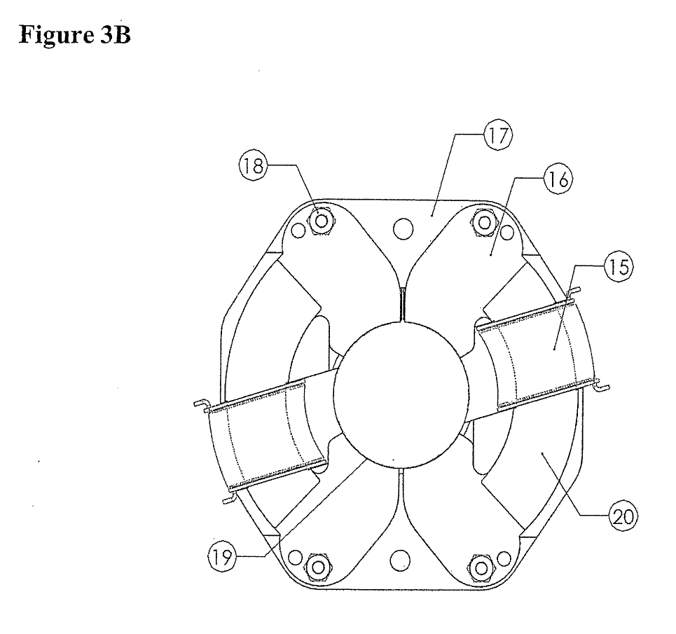

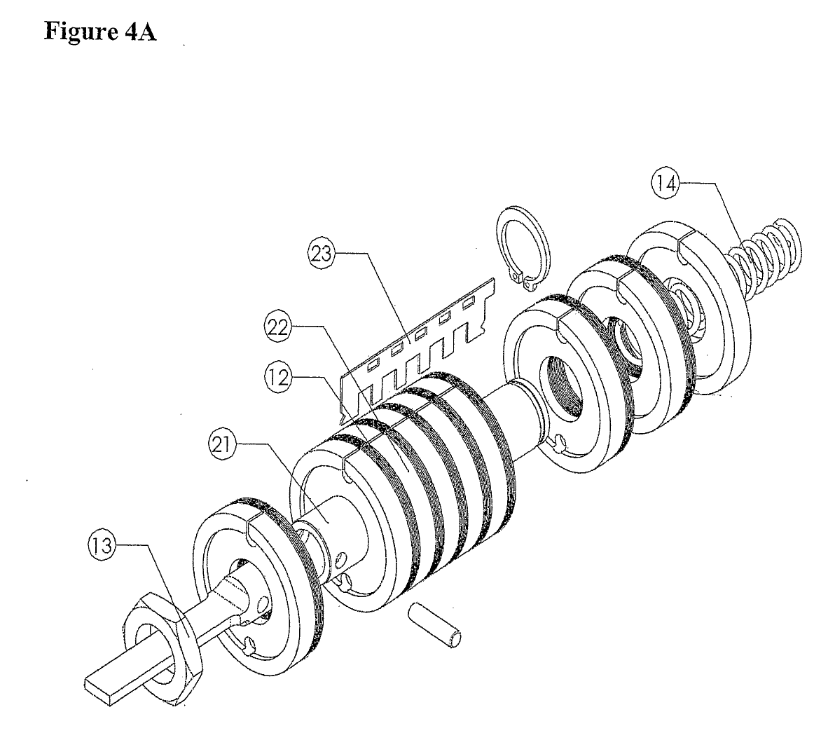

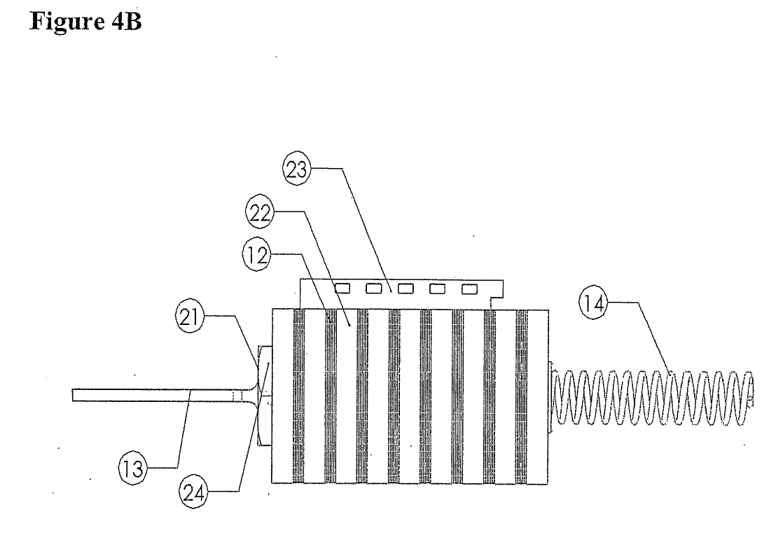

FIGS. 4A, B and C show two 3D views and a side view of the shuttle 10 with the driver 13 and return spring 14. The shuttle can be built in several ways but this picture shows a tube 21 made of non-magnetic material like aluminum or stainless steel.

On the periphery of the tube, several magnetic sheet metal parts are stacked together to a shuttle iron core 12 and in between each shuttle iron core 12 a shuttle distance 22 made from non-magnetic material is located to give the right spacing between each shuttle iron core. The whole shuttle package is held together by a stop 26 in one end of the tube 21 and a nut 24 in the other end by means of which the laminate package can be pressed together. The laminated shuttle iron core 12 will function as a bridge for the magnetic field to move from one pole face 19 over the air gap to the next air gap and pole face in the first and second magnetic yoke assemblies 8 and 9. As long as the shuttle iron core 12 is on its way into a yoke the magnetic field will pull the shuttle iron core to line up inside the yoke assembly.

On one end of the tube 21 the driver 13 is assembled with some mechanical fastener to the tube to hold the driver in position in relation to the shuttle. The driver 13 may by guided inside the tube to make it easy for the driver to guide into the fire rail 6 when the shuttle is on its way down to impact a nail, tack or staple. On the other side of the tube 21 the spring 14 is located at least partly inside the tube and one end of the spring will rest against a stop inside the tube like the end of the driver 13 or some other stop. The other end of the spring will rest on the surface of the top cover of the housing 4. A pin assembled to the housing top cover 4 will stick down inside the spring 14 to guide the part of the spring, which not are guided by the tube 21.

In FIG. 4C the last shuttle distance 22 is removed to show the extra shuttle iron parts 25 that will add extra section area to the shuttle iron core so that the shuttle iron core will have the same area as one pole face has. The magnetic field path has to have the same area as the pole faces to avoid unnecessary limitations for the flow of the magnetic field depending on the saturation of the field.

Along one side of the shuttle body a timing bar 23 is assembled. The main purpose for the timing bar is to indicate to sensors (to be described below) located between the yokes inside the distances 17 where the shuttle is located in relation to the different yokes. At the same time the signals from the sensors can be used to calculate the speed of the shuttle. A second use for the timing bar 23 is to inhibit the shuttle to rotate around its center axis to avoid the magnetic area in the shuttle iron to be reduced by the assembly slots holding the timing bar.

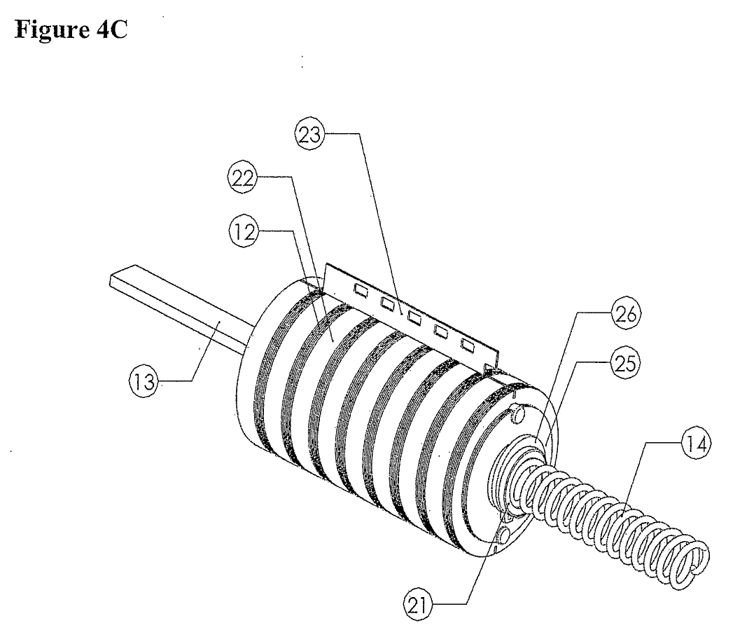

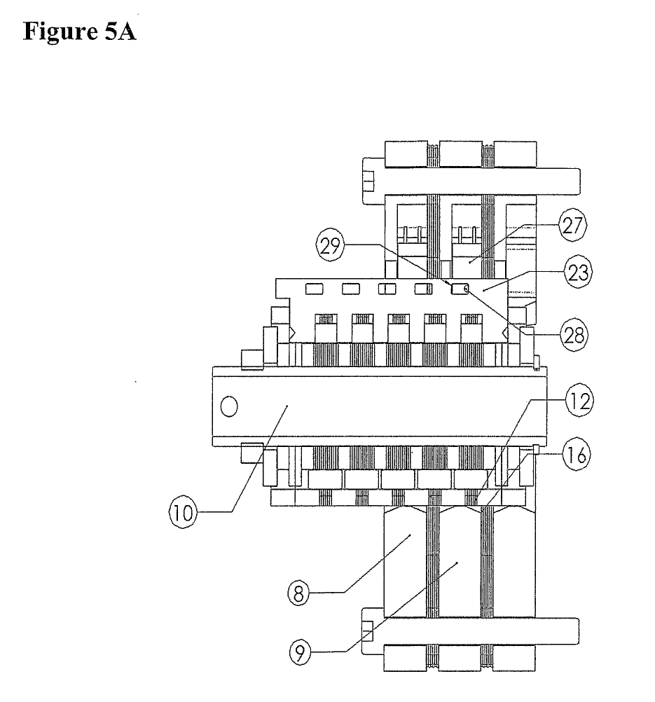

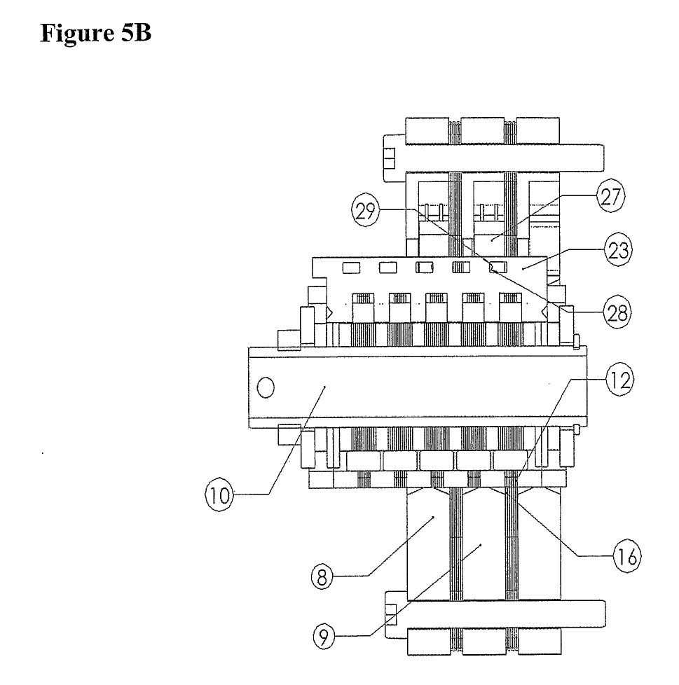

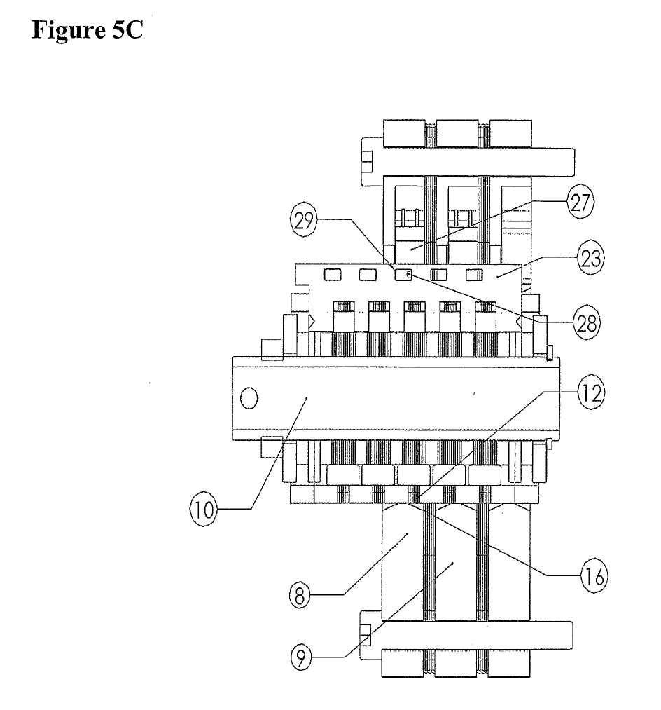

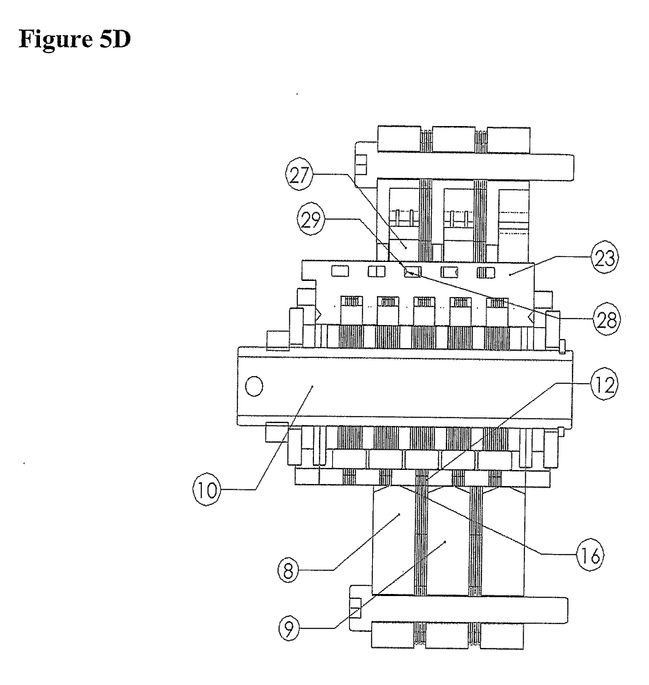

FIGS. 5A, B, C and D show a start and stop position and the relation between the timing bar 23 and the sensors 27, for example comprising a light beam cooperating with a detector. Several timing concepts can be used but in these four figures one of many different possible concepts are explained.

In FIG. 5A the shuttle 10 is in its starting position for a return movement and for simplicity only two yoke assemblies are showed, i.e. the first yoke assembly 8 and the second yoke assembly 9. The shuttle iron core 12 is just positioned in front of the yoke 16 in yoke assembly 9. The distance between shuttle iron core 12 and the yoke 16 is approximately 0.8 to 0.5 mm. In this moment a light beam 28 generated by the sensor 27 located in the distance 17 is shining through the window 29 in the timing bar 23 and a signal is informing the logic circuits in a control unit (not shown in the drawings) to energize the coils 15 in the yoke assembly 9. When the coils are energized a magnet field is generated which will pull the shuttle 10 to the position in FIG. 5B. In FIG. 5B the shuttle 10 and shuttle iron core 12 has moved to a position in which the shuttle iron core 12 is lined up with the yoke 16 and at that moment the window 29 is on its way to shut the light beam 28 off. With no signal out from the sensor 23 the magnetic field will go off and the shuttle will continue by its own inertia 0.1 to 0.2 mm to the position in FIG. 5C. In FIG. 5C the next shuttle iron core 12 is in front of the yoke 16 in the first yoke assembly 8 and the light beam 28 from the other sensor 27 in the first yoke assembly 8 will shine through the next window 29 in the timing bar 23. The new sensor 27 will now indicate to the logic that it is time to energize the first yoke assembly 8 and the magnetic field will pull the shuttle 10 to the position in FIG. 5D. In FIG. 5D the shuttle iron core 12 has moved into yoke 16 in yoke assembly 8 and the window 29 will close the light beam 28 and the magnetic filed in yoke assembly 8 will be shut off. At this moment the process will start all over again from FIG. 5A. If the design now has more yokes like four, six or eight yokes, several of the yokes will be on parallel but in a staggered mode.

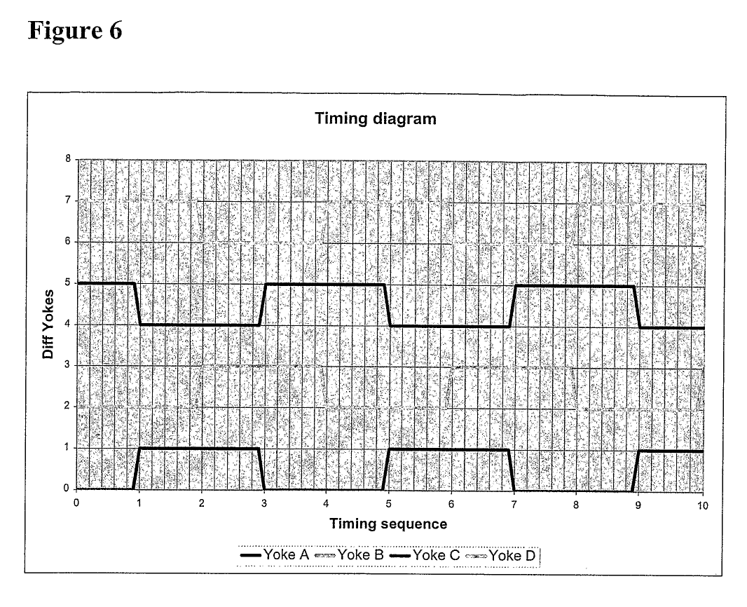

FIG. 6 will show a timing curve for four yokes like the design in FIGS. 2A and B. The four yokes are named A to D and yoke A is the lowest curve, yoke B the second one, yoke C the third one and finally yoke D is on top. At sequence zero, yokes D and C are on but when yoke C is going off yoke A will go on and than yoke D is going off yoke B will go on. In this manner the different yokes will be on and off in a staggered mode. Sometimes when one yoke goes off and the next on it will take a movement of 0.1 to 0.2 mm of the shuttle between the on and off sequence. If the motor has six or eight yokes the timing will be in the same manner but three or four yokes will be on the same time but staggered in sequence like in FIG. 6.

Other timing concepts can be used. In FIG. 5 only two yokes were used but instead of yoke 8, two or three yokes could be arranged mechanically in a way so that they work in a parallel manner. If we for example have four yokes it means that two yokes go on at the same time. The other two yokes also go on at the same time but after the first two go off.

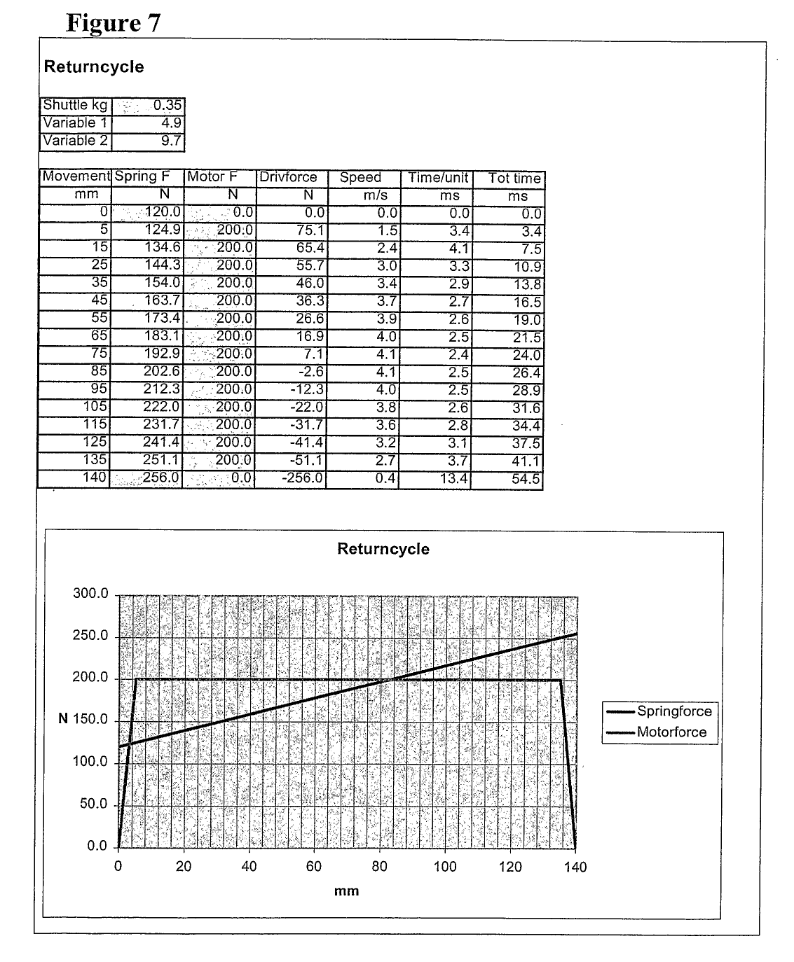

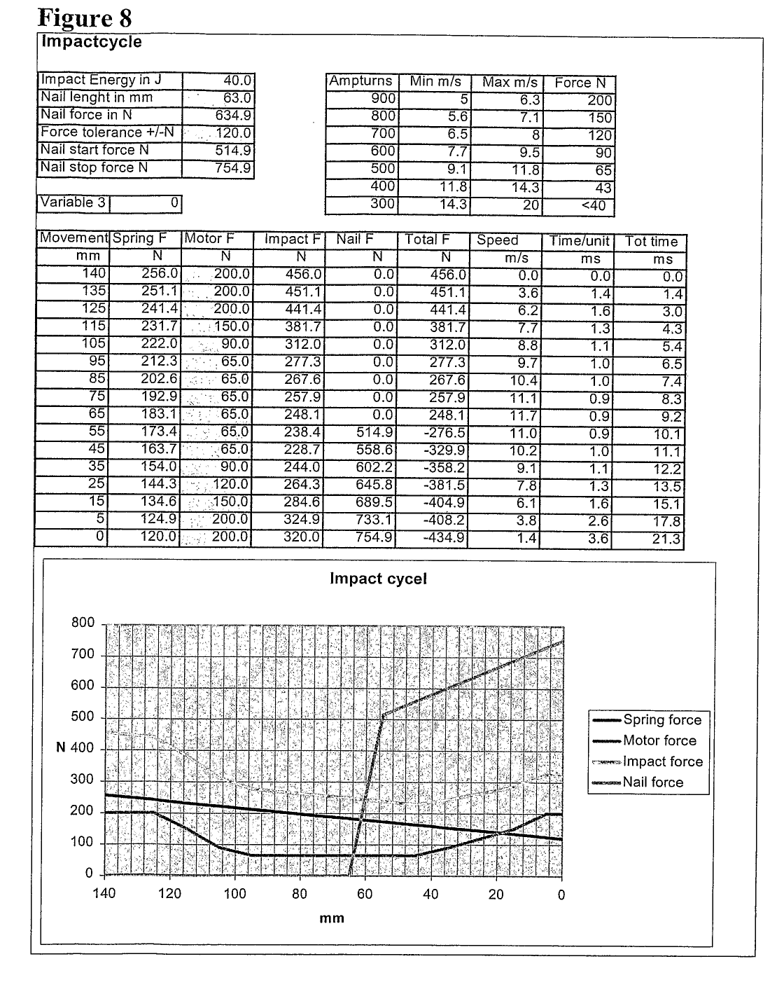

FIG. 2B shows the shuttle 10 in its low position which means that the tip of the driver 13 is lined up with the low tip of the fire rail 6. On a command from the trigger 2 the motor starts to move the shuttle 10 backwards and the force made by the motor has to be higher than the force from the spring 14 to make the shuttle move. FIG. 7 shows two curves, one is the motor force and the other the spring force. To start the motor the spring has a starting force of 120 N and the motor has 200 N in average force. The shuttle starts to move and the speed increases up to 4.1 m/s after 85 mm of movement. At this point the spring curve crosses over the motor curve and the speed will slow down close to zero after 140 mm movement. The whole back up movement will take 54.5 ms in time. At the shuttle top position the spring 14 is totally compressed and located inside the shuttle 10 and at this moment the shuttle stops and immediately starts to move forward. FIG. 8 shows the forward or the impact movement and it is now two forces moving the shuttle forward the force from the compressed spring and the force from the motor. The motor force may fall down below 200 N at a speed over 6 to 10 m/s due to limitations in rise time for the current passing through the coils 15 and also depending on the thickness of the yoke 16 and other motor parameters. For this reason, there is a dip in the motor force curve.

In this simulation it is assumed that the tacker tool has to drive down a nail which is 65 mm long with one return and impact shuttling. FIG. 8 shows that it needs 40 J of energy to impact a 65 mm long nail, 40 J is equal of a force rising from zero N to 514.9 N after 10 mm nail penetration and ends with 754.9 N after full nail penetration into its foundation. The shuttle starts the impact cycle and the speed increases up to 11.7 m/s at the time it impact the nail and after that the speed slow done to 1.4 m/s which means that the nail will be driven down with only one return and impact cycle. The total impact cycle will take 21.3 ms and the return cycle 54.5 ms, which means a total time of 75.8 ms.

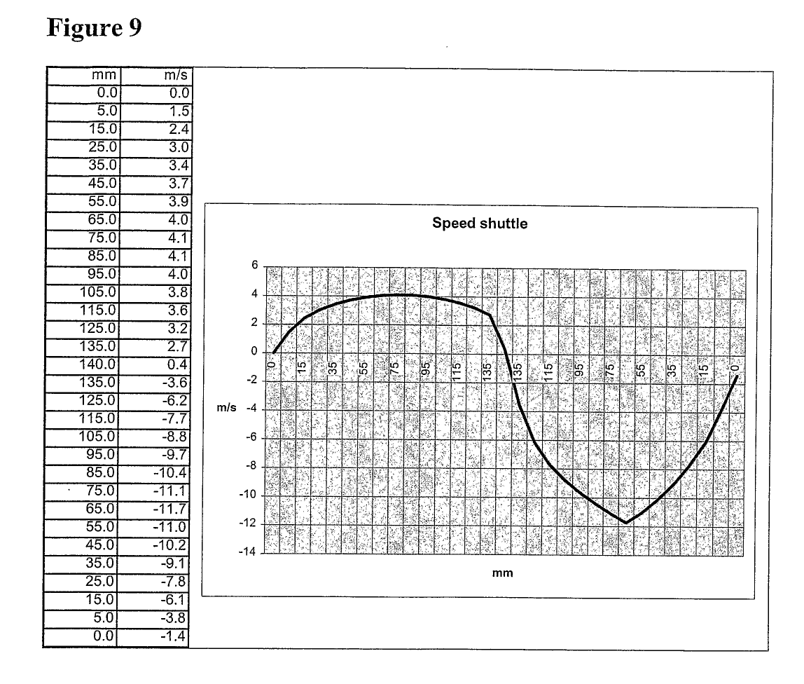

FIG. 9 shows the shuttle speed in relation to the shuttle position. The return speed depends on the shuttle weight, motor force and spring force. The shuttle will reach a speed of up to 4 to 8 m/s as a peak and slow down to zero m/s at the top position. At the impact cycle it is important to reach as high speed as possible and it depends on the same parameters as the return cycle and as well on the dip in the motor curve. A typical top speed will be between 10 to 15 m/s just before the impact between driver 13 and the nail and after that it reduces to zero m/s. As the tacker tool has a micro computer controlling the timing and shuttle speed it can determine if the motor has to reduce the force in the end of the cycle to inhibit the nail to impact too deep into its foundation. If the opposite happens, i.e. the microcomputer finds that the shuttle has too low speed to drive the nail totally down it has no way to increase the spring or motor force. To overcome this problem it can immediately start to return the shuttle a second time after it has stopped and depending on how many millimeters nail penetrating which is left over it will return the shuttle the appropriated amount and from that position make a second impact cycle to move the nail further down into its foundation. This can happened because 40 J of impact energy is based on normal wood material but if the nail for example has to penetrate into a harder wood type one shuttle cycle may not be sufficient to move the total length of the nail down into its foundation. Therefore it is important to have control over the shuttle speed and determine if a second impact cycle is needed or if the speed has to be reduced by reducing the motor force to control the impact of the nail, tack or staple into its foundation.

The size and cost of the tacker or staple tool motor and return spring can be reduced if the impact of a nail, tack or staple is based on minimum two or three shuttle cycles. One cycle only take approximately 75 to 100 ms two full or almost full cycles will not take no more than approximately 150 to 200 ms. As the two cycles is performed during a very short time it is not possible for the operator to determine if one, two or even three cycles is used to impact the nail, tack or staple. With this concept one size of tacker or staple tool can cover a wider range of different nails, tacks or staples. If the concept with double impact is used it is important that the microcomputer has a good control over the shuttle speed and that the shuttle can start a return movement from any stop position as the nail, tack or staple can stop in any place after the first impact depending on the hardness of the material in the foundation. If the microcomputer is informed abut how many millimeters the nail, tack or staple has to be moved the second time it can calculate how long it has to return the shuttle the second time to generate the right amount of energy to impact the nail, tack or staple with the second movement.

When the shuttle has pushed down a nail, tack or staple into its foundation it will stand in its home position. In the home position the energy absorbing spring will give the shuttle a slight pressure to hold the shuttle in this position.

If now the operator of the tool likes to drive down a nail, tack or staple the linear motor starts to move the shuttle backwards and compress the spring. At the highest point, or back position, of the shuttle the spring is compressed and all the kinetic energy from the return movement of the shuttle is saved in the spring. From the back position the shuttle now immediately starts the forward or impact movement and accelerates to high speed with help of the linear motor and the compressed spring. During the return and impact shuttle motion the nail, tack or staple feed system will feed in a new nail, tack or staple into its fire rail. The shuttle has reached its highest speed just as the driver impacts the top of the nail, tack or staple and the kinetic energy in the shuttle will be converted to a force which together with the force from the spring and motor constitutes a total force which will move the nail, tack or staple into the foundation.

According to a particular embodiment, the invention can be arranged in the following manner. If the impact energy from the shuttle is not high enough to move a long nail or staple into its foundation the shuttle will immediately start a new return movement and make a second impact motion to impact the nail or staple a second time, or possibly even several times.

If a long nail or staple has not been impacted after several shuttle motions the tool may give up and inform the operator that something is wrong.

The linear motor which drives the shuttle consists of a minimum of two electromagnetic yokes made from soft laminated magnetic iron. The yokes are spaced after each other with the same spacing or variable spacing depending on the timing concept. The number of yokes depends on the energy output, which are demanded from the tacker or staple tool in question. Every yoke has one or two electric coils connected through a power transistor to the battery. The yoke has two magnetic poles and in between these poles is the shuttle moving with a controlled air gap between the poles and the shuttle.

The shuttle has also several soft laminated magnetic iron cores spaced at a constant distance from each other. When a shuttle iron core is on its way to enter in between two poles in one yoke the power transistor will open and current will flow through the coils and a magnetic filed is produced inside the yoke. The magnetic field will now flow from the north pole in the yoke over the air gap, through the iron core in the shuttle, over the second air gap and into the south pole on the yoke. As long as the iron core in the shuttle is on its way in, in between the poles in the yoke the magnetic field in the two air gaps on each side of the shuttle iron core will generate a forward force to move the shuttle. At that moment the shuttle iron core is lined up with the pole faces in the yoke the power transistor will close and no more magnetic filed excite inside the yoke.

If the motor for example has four yokes named A, B, C and D the timing of the yokes will be A/D, A/B, B/C, and C/D and after that the timing will repeat again. If the spacing of yokes and iron cores in the shuttle and timing is right approximately 50% of all the yokes will be activated to produce a forward force on the shuttle.

The shuttle can be designed as a long round or rectangular bar with soft laminated magnetic iron cores with approximately the same width as the width of the pole faces.

An alternative design can use permanent magnets in the shuttle instead of soft laminated magnetic iron cores. If permanent magnets are used it is possible to use up to 100% of the yokes at the same time if the driver transistors for the coils on the yoke can drive the current in both directions through the coil. If the current direction can alternate the north and south poles in the yoke this alternation will pull the shuttle magnet into the air gap and push the shuttle magnet out of the air gap.

The spacing of these soft magnetic iron cores has to have a relation to the spacing between the yokes to achieve an optimum of yokes to be activated during a shuttle motion. The shuttle will be guided in a bearing system with high accuracy in relation to the yokes to maintain the proper air gap between the iron cores in the shuttle and the pole-faces in the yokes, a typical air gap has to be between 0.05 to 0.1 mm. The spring in the shuttle can partly be guided inside the shuttle and partly by some guiding bar in the tool housing. On the opposite side of the shuttle is a small rectangular hardened steel bar in the form of a driver arranged, which will be guided into the fire rail where a nail, tack or staple are located to impact the nail, tack or staple. The driver is fastened to the shuttle by some shock absorbing material to reduce the impact shock.

On the shuttle a timing-bar is located and in between some of the yokes some sensors are located which can work according to either optical or magnetic principles. The sensors will generate a set of electrical timing pulses, which has a relation to the physical positioning of the shuttle within an accuracy of ±0.1 mm to serve as an input to the microcomputer.

According to alternative embodiments, the sensor can be in the form of a light source (for example a LED or a laser) which cooperates with a light detector, or can be in the form of an inductive detector.

The purpose of the microcomputer is first to open and close the power transistors controlling the current to the coils based on the input from the shuttle sensors. Secondary the computer will preferably check several things like if a long nail or staple is pushed the whole way into its foundation or if a secondary shuttling movement is needed. It will also check if a nail, tack or staple is located in the fire rail, the condition of the battery charge and other things. Finally the computer will also inform the operator of the condition of the tool if it is time to make different activities like changing battery, fill up nails, tacks or staples or to make other service work on the tool.

To control all these activities the microcomputer has a program located in a memory. The program can be updated or changed by replacing a memory stick, which makes it possible to change the character of the tool, when replacing the feeder system from feeding nails to feeding staples or some other change. The program can also be updated depending on the type of foundation for which the tool shall be used.

The operator can be informed through a display or through a sound information system in the tool about information from the program.

To push in a nail, tack or staple into its foundation, energy is needed and that energy will come from a battery attached to the tacker or staple tool. The battery will also be the power source for the microcomputer and sensors.

The battery can be of a Nickle-Metalhydride, Lithium Ion or Lithium-Polymer type. The two most important battery parameters are high power content per gram weight and high current output within the shuttle movement. The battery will be rechargeable and easy to replace. The energy contents in a normal battery will meet several thousand impacts before it is time for recharging.

The output of the battery can also be parallel connected to a capacitor to protect the battery to be damaged from the high current output during one shuttle movement operation.

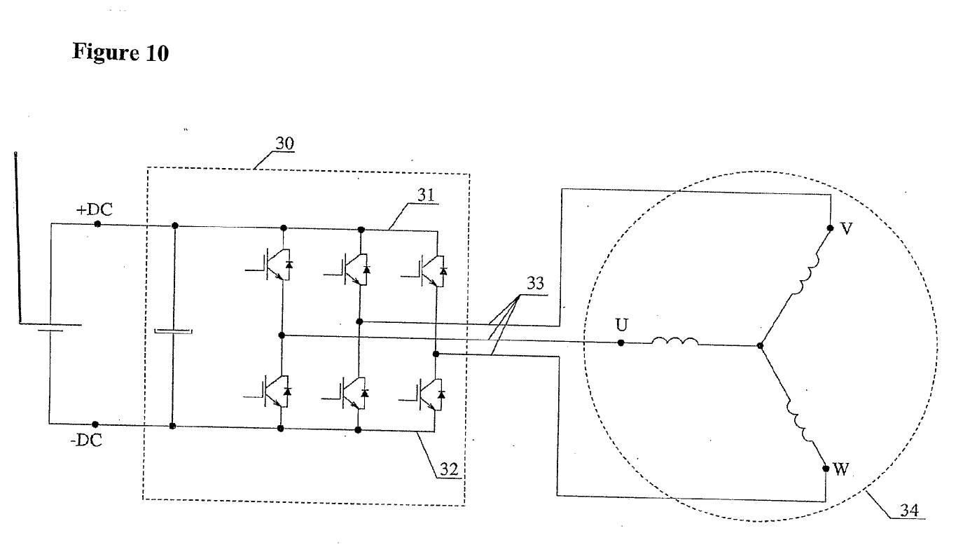

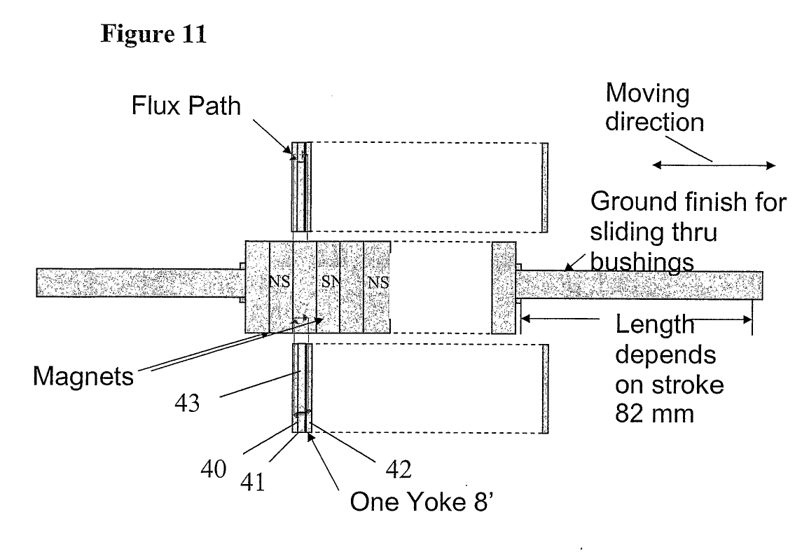

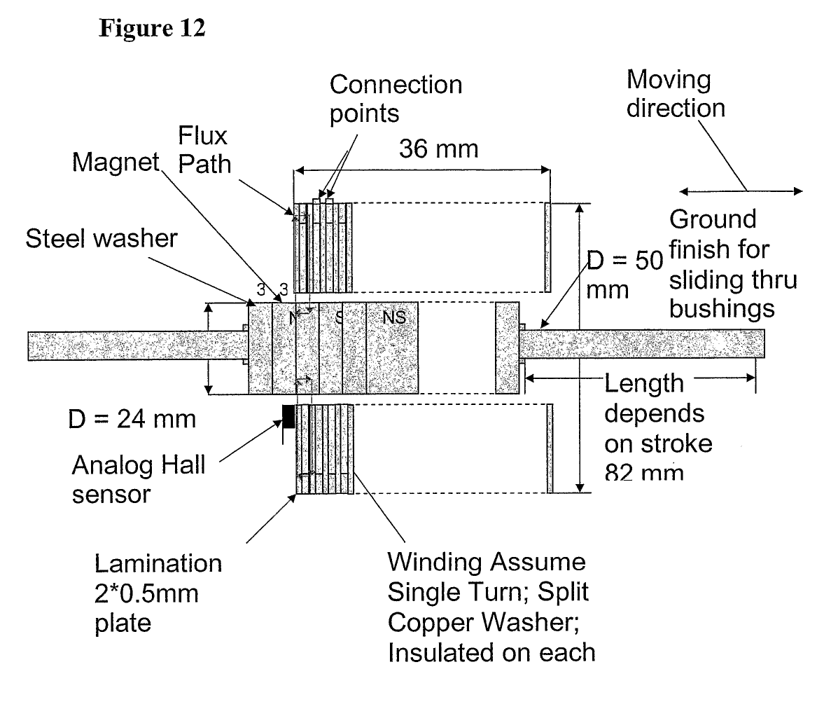

An alternative design of the invention will now be described with reference to FIGS. 10-12. Said alternative design makes use of permanent magnets in the shuttle (rotor) 10′ instead of soft laminated magnet iron cores. The permanent magnets are preferably arranged along the longitudinal direction of the shuttle, as shown in FIGS. 11 and 12. Preferably, the shuttle also comprises steel washers (see indication in FIG. 12). Also, when permanent magnets are used, another realization of the yoke assembly 8′ is made.

The drive 30 that is converting the dc current into ac current can be of three-phase type as shown in FIG. 10. The drive consist of six power switches, switching the current between the plus bar 31 and minus bar 32. The plus and minus bars 31, 32 are connected to the respective +DC and −DC terminal of the battery. By three-phase connection 33 from drive to motor the different legs of the drive are connected to the linear motor 34.

The yoke assembly 8′ of the motor can in the case of a permanent magnet shuttle (rotor) be made U-shaped by iron laminations divided into different laminations 40, 41, 42 as shown in FIG. 11. The space in the middle of the U is filled with a winding, preferable insulated copper wires or copper plates.

Current in the winding, generated by the drive, will generate a magnetic field in the yoke that will pass the air-gap to the shuttle (rotor) directed generally perpendicular to the direction of movement of said shuttle 10′ shown by the flux path in FIG. 11.

Different connections of the windings in the yoke assembly 8′ can be made. Three yokes, one per phase, can be combined into a Y-connected three-phase motor winding. Alternatively, six yoke assemblies or different other multiples of three can be combined. For the permanent magnet shuttle (rotor), the yoke assemblies 8′ can be assembled tight beside each other. Also laminations 42, 41 can magnetically be shared between two yokes.

In the permanent magnet case, the air-gap between the yokes and the shuttle can be increased to a range of millimetres allowing lower mechanical tolerances in the motor assembly. The above examples describe a three-phase arrangement, other arrangements of the power switches and yokes, giving other phase-count than three is considered obvious to anyone skilled in the art.

The dimensions and materials given in FIGS. 11 and 12 should be considered as examples only. The invention is not limited to any particular dimensions or any embodiment as described above, but can be varied within the scope of the enclosed claims. For example, the invention can be used with a battery, which can be rechargeable, or by means of a conventional power supply with a cord intended to be plugged into an electrical socket, for example having a voltage of 110 or 220 V.

1. An electrically powered tool for fastening elements and comprising
a moving shuttle connected to a driver, and
an actuator motor having at least two electromagnetic yoke assemblies, cooperating with said shuttle which is arranged to be displaced in relation to said yoke assemblies (8, 9),
wherein each yoke assembly includes electric coils arranged for generating a magnetic field through the shuttle, and
a control unit which controls the current in the coils to generate a magnetic field so that a force is generated for displacing said shuttle, wherein the yoke assemblies are arranged for generating a magnetic field which is directed generally perpendicular to the direction of movement of said shuttle.

2. A tool according to claim 1, wherein the shuttle comprises a number of spaced-apart iron cores.

3. A tool according to claim 1, wherein the shuttle is arranged to move in between the pole faces of all the yoke assemblies.

4. A tool according to claim 1, wherein the shuttle is arranged to be guided by a bearing system to maintain a predetermined air gap between the iron cores and the pole faces of the yoke assemblies.

5. A tool according to claim 1, wherein the shuttle has a driver pin attached in one end of the shuttle to impact the head or top of said fastening element to push into its foundation.

6. A tool according to claim 1, wherein the shuttle includes a spring which is at least partly located inside the shuttle and will take up kinetic energy from the back up movement of the shuttle.

7. A tool according to claim 6, wherein the shuttle is arranged to move backwards and compress the spring and forward with help from both the spring forces and magnetic forces from said motor.

8. A tool according to claim 1, wherein the shuttle is arranged to move several times back and forward and at every shuttle movement impact said fastening element to some degree.

9. A tool according to claim 1, further comprising a sensor device to sense the position of the shuttle and forward information related to said position to said control unit.

10. A tool according to claim 9, wherein the control unit includes a microcomputer to process the information from the sensors so that said control unit may initiate a flow of current to the coils in the yoke assemblies and generate the magnetic field which generate the force to move the shuttle forward.

11. A tool according to claim 1, wherein said control unit is arranged to determine the firing time for every individually magnetic yoke assembly and to keep track of the number of impacts and if a fastening element is located in right position before impact.

12. A tool according to further comprising a battery, which will power the coils on the yoke assemblies.

13. A tool according to claim 12, wherein the battery is rechargeable in a separate charge unit and can be replaced by a new charged battery.

14. A tool according to further comprising a sensor for the amount of energy left over in the battery to inform the operator in time to replace the battery with a new or recharged one.

15. A tool according to claim 1 further comprising a feeder cassette for fastening elements, the feeder cassette to move a fastening element in position into a fire rail in front of the driver attached to the shuttle so as to move the fastening element into the foundation in a guided manner.

16. A tool according to claim 1, wherein the shuttle comprises a plurality of permanent magnets arranged along the longitudinal direction of the shuttle.
